(19) United States
(12) Patent Application Publication
(10) Pub. No.: US 2025/0182160 A1
(43) Pub. Date: Jun. 5, 2025

(54) System and Method for Presenting Information on a Mobile Device

(71) Applicant: Dana Industries Inc., Etobicoke (CA)

(72) Inventors: John RICCI, Kleinburg (CA); Frank BORGES, Toronto (CA)

(73) Assignee: Dana Industries Inc., Etobicoke (CA)

(21) Appl. No.: 19/048,673

(22) Filed: Feb. 7, 2025

Related U.S. Application Data
(63) Continuation of application No. 18/161,075, filed on Jan. 29, 2023.
Application No. 18/161,075 is a continuation of application No. 16/740,274, filed on Jan. 10, 2020, now abandoned.
Application No. 16/740,274 is a continuation of application No. 15/119,697, filed on Aug. 17, 2016, now abandoned.
(60) Provisional application No. 61/940,490, filed on Feb. 17, 2014.

(51) Int. Cl. G06Q 30/0251; H04W 4/02

(52) U.S. Cl. CPC G06Q 30/0261; G06Q 30/0259; H04W 4/023

(57) ABSTRACT

A system for presenting a merchant page on a mobile device comprises a server, a database accessible by the server, and a mobile device. The database comprises a plurality of merchant pages associated with merchant information. The mobile device is configured to scan a machine-readable code encoding the merchant information. The mobile device is further configured to transmit to the server a signal responsive to the machine-readable code being scanned by the mobile device. The server, in response to receiving the signal from the mobile device, is configured to transmit the relevant merchant page associated with the merchant information to the mobile device. A method for presenting a merchant page on a mobile device is also provided.

### CROSS REFERENCE TO RELATED APPLICATIONS

The present application is a Continuation of U.S. application Ser. No. 18/161,075, filed on Jan. 29, 2023, which is a Continuation of U.S. application Ser. No. 16/740,274, filed on Jan. 10, 2020, which is a Continuation of U.S. application Ser. No. 15/119,697, filed on Aug. 17, 2016, which is a National Entry of PCT Application Number PCT/CA2015/050116, filed on Feb. 17, 2015, which claims priority under the Paris Convention to U.S. Application No. 61/940,490, filed on Feb. 17, 2014. The entire contents of the aforementioned applications are incorporated herein by reference.

### FIELD OF THE INVENTION

The present invention generally relates to systems and methods for presenting information, such as information from a merchant, on a mobile device. In particular, the present invention is related to systems and methods for presenting one or more merchant pages stored on a database in response to the mobile device scanning and decoding a machine-readable code.

### BACKGROUND OF THE INVENTION

Many merchants and retailers offer in-store discounts, promotions and special offers to their customers and potential customers. Traditionally, information relating to such in-store promotions has been advertised using paper flyers and public and/or in-store signage. In addition to such traditional methods, many merchants and retailers have recently begun using online resources, such as the merchant's website or a social media account maintained by the merchant, to advertise their in-store promotions.

However, such in-store promotions are often only valid for a relatively short period of time, and in some cases, offered exclusively at select merchant or retailer locations. As such, customers viewing online information about an in-store promotion may find that that the promotion they are viewing is not relevant for the timeframe and/or the store location they are planning to visit. Moreover, customers, particularly those who are new to a merchant's website, may find the process of selecting a store location and navigating the merchant's website to locate in-store promotion details cumbersome and time consuming.

Merchants and retailers expend considerable resources updating their flyers and signage posted throughout the stores every time their in-store promotions change. This is particularly burdensome for large merchants and retailers having multiple store locations and/or large retail spaces. Conventionally, signs, such as those advertising items on sale, are positioned adjacent to or near the items that the signs relate to and are used to provide information to customers. However, the effectiveness of such flyers and in-store signs are often somewhat limited. This is due to the fact that flyers and in-store signs are only seen by attentive customers in particular aisles or locations within the stores where such flyers and in-store signs are displayed. Moreover, with such advertisement system, it is often difficult for a customer visiting the store to determine if a particular item is on sale, since such information is generally posted only in the respective aisle or location within the store where the item is being sold. Alternatively, the customer may choose to use a mobile device to access and navigate the store's website to determine if the item is on sale. However, doing so may be cumbersome and time consuming for the reasons provided above. Additionally, flyers advertising in-store promotions are often large in size, thus limiting the locations where such flyers may be displayed or distributed.

Some attempts have been made at providing relevant information regarding a product, brand, or on-going promotions offered at the retailer location to customers visiting a store.

For example, U.S. Pat. No. 8,479,975 to Boone et al. describes a system for using machine-readable indicia to provide additional information concerning a given product to potential customers. Such indicia may comprise 1 D or 2D codes, such as barcodes or QR codes. However, the information retrieved by the user's mobile device in such system is generally limited to additional information about the specific product associated with the machine-readable indicia that is scanned.

U.S. Pat. No. 8,413,884 to Lim et al. describes a computer server system that includes a memory for storing a plurality of separate merchant site addresses, or uniform resource locators (URLs), and rules for selecting one or more merchant website addresses from the plurality of site addresses and present same to a user. Such rules are based on the geographic location, the time and the weather conditions associated with the user. Upon the user scanning a hardlink code, such as a QR code, using a wireless device at a merchant's site, the server redirects the user's wireless device to the relevant merchant website address in response to the rules. Therefore, apart from updating its website, the merchant is not able to control the information presented to a user.

There exists a need for an improved system and/or method for presenting a user with specific information from a merchant.

### SUMMARY OF THE DESCRIPTION

In one aspect, there is provided a method and system for displaying information provided by a merchant on a mobile device of a user. The information is preferably in the form of a page, such as a webpage, referred to herein as a “merchant page”. The information is displayed in response to the scanning by the user, through the mobile device, of a machine readable code, such as a barcode or a QR code. The merchant pages are stored on a server and are maintained by the merchant through a merchant interface. As will be understood, one advantage of the present invention is the ability of the merchant to directly and independently modify the information delivered to the user at any time.

Thus, in one aspect, there is provided a method for transmitting a relevant merchant page to a mobile device over a wireless communication network, the method comprising:
receiving at a computer server, a signal from the mobile device, the signal being indicative of the scanning of a machine-readable code by the mobile device;
identifying merchant information encoded by the machine-readable code;
accessing a database accessible by a computer server, the database containing a plurality of merchant pages;
identifying in the database, the relevant merchant page, wherein said relevant merchant page comprises a merchant page associated with the identified merchant information; and,
transmitting the relevant merchant page to the mobile device.

In another aspect, there is provided a system for presenting a relevant merchant page on a mobile device, the system comprising:
a computer server connected to a wireless communication network;
a database accessible by the server, the database comprising an electronic memory having stored thereon one or more merchant pages associated with merchant information;
a communication device for receiving from the mobile device, a signal indicative of a scanned computer-readable code and for transmitting to the mobile device, the relevant merchant page;
a processor, associated with the server, the processor being operable to identify merchant information from the signal and to identify the relevant merchant page stored on the database for transmitting to the mobile device wherein the relevant merchant page is associated with the merchant information.

In another aspect, there is provided a computing device for transmitting a relevant merchant page to a mobile device, the relevant merchant page being relevant to information encoded on a machine-readable code, the computing device comprising:
a database comprising an electronic memory having stored thereon one or more merchant pages, the merchant pages being associated with merchant information;
a processor configured to:
   receive a signal from the mobile device, the signal being responsive to a machine-readable code being scanned by the mobile device;
   identify merchant information associated with the signal;
   identify the relevant merchant page from the database, the relevant merchant page being a merchant page associated with the merchant information; and,
   transmit the merchant page to the mobile device.

In another aspect, there is provided a method for transmitting at least one relevant merchant page to a mobile device over a communication network, the method comprising:
receiving at a computer server, a signal from the mobile device, the signal being indicative of the presence of the mobile device at a merchant location;
identifying merchant information encoded by the signal;
accessing, by the computer server, a database containing a plurality of merchant pages, each of said merchant pages being associated with merchant information;
identifying in the database, the at least one relevant merchant page, wherein said at least one relevant merchant page comprises at least one merchant page associated with the merchant information identified in the signal; and,
transmitting the at least one relevant merchant page to the mobile device.

In another aspect, there is provided a system for presenting at least one relevant merchant page on a mobile device, the system comprising:
a computer server connected to a communication network;
a database accessible by the server, the database comprising an electronic memory having stored thereon a plurality of merchant pages, each of said merchant pages being associated with merchant information;
a communication device for: (i) receiving a signal from the mobile device, the signal encoding merchant information corresponding to a merchant location and being generated in response to the presence of the mobile device at the merchant location; and (ii) transmitting to the mobile device the at least one relevant merchant page;
a processor, associated with the server and the communication device, the processor being programmed to: (i) identify the merchant information encoded by the signal; (ii) identify the at least one relevant merchant page stored on the database, wherein the at least one relevant merchant page is associated with the identified merchant information; and (iii) instruct the communication device to transmit the at least one relevant merchant page to the mobile device.

In another aspect, there is provided a computing device for transmitting at least one relevant merchant page to a mobile device, the at least one relevant merchant page being relevant to information encoded in a signal transmitted by a mobile device, the computing device comprising:
a database comprising an electronic memory having stored thereon a plurality of merchant pages, each of the merchant pages being associated with merchant information;
a processor configured to:
   receive a signal from the mobile device, the signal encoding information relating to the presence of the mobile device at a merchant location;
   identify merchant information encoded in the signal;
   identify the at least one relevant merchant page from the database, the at least one relevant merchant page being the merchant page or pages associated with the merchant information encoded in the signal; and,
   transmit the merchant page to the mobile device.

### BRIEF DESCRIPTION OF THE DRAWINGS

The features of certain embodiments of the invention will become more apparent in the following detailed description in which reference is made to the appended drawings, wherein:

FIG. 1 is a diagram illustrating the system according to one embodiment;

FIG. 2 is a diagram illustrating a database according to one embodiment;

FIG. 3 is a flow diagram illustrating a method for presenting a merchant page on a mobile device according to one embodiment;

FIG. 4 is a flow diagram illustrating a method for presenting a merchant page on a mobile device according to another embodiment.

### DETAILED DESCRIPTION OF THE PREFERRED EMBODIMENTS

As used herein, the term “mobile device” will be understood to mean a handheld communication device that incorporates a reader for reading encoded information. Typical mobile devices include cell phones, smartphones or tablet devices, such as an iPhone™, an iPad™, a Blackberry™ device, an Android™ device and the like. The invention is not restricted to any particular mobile device. Preferably, the mobile device includes a means for receiving and displaying encoded information. For example, the mobile device would preferably include a user interface, such as a web browser, that allows the display of information such web pages and the like. Alternatively, the mobile device may include a messaging program for receiving and displaying text messages and the like.

A “reader” as used herein comprises a detecting device or mechanism provided on a mobile device and which is capable of scanning or reading a code encoding information. Generally, the encoded information is in the form or a 1 or 2 dimensional code, such as a barcode or QR code, which are known in the art. Various other methods of encoding information would be known to persons skilled in the art and such persons would understand that other information encoding systems may be incorporated into the presently described method and system. A typical reader would comprise a camera on the mobile device, in association with any decoding software for decoding information encoded in the code.

As used herein, the term “database”, as used in reference to the system described herein, will be understood to mean a computer readable medium stored on one or more server computers and which encodes one or more merchant pages as well as the related merchant information.

As used herein, the term “merchant page” will be understood to mean electronic data that is stored in the database and which can be transmitted to the mobile device by the server. For example, the merchant page may be a web page including text, image, audio, and/or video data that can be transmitted to a mobile device. A given merchant can have one or more merchant pages stored on the database.

As used herein, the term “merchant information” will be understood to be any information that is associated with a merchant page stored in the database, and which may be used by the server to identify the merchant page. Examples of merchant information include, but are not limited to, a merchant identifier and a merchant location identifier. In one embodiment, the merchant pages may be indexed in the database according to one or more merchant information.

The terms “comprise”, “comprises”, “comprised” or “comprising” may be used in the present specification. As used herein (including the description and/or the claims), these terms are to be interpreted as specifying the presence of the stated features, integers, steps or components, but not as precluding the presence of one or more other feature, integer, step, component or a group thereof as would be apparent to persons having ordinary skill in the relevant art.

In one aspect, a system is provided for presenting a merchant page on a mobile device, the system comprising a server, and a database that may be stored on or otherwise accessible by the server. The system is configured to allow user mobile devices to access the merchant pages, as discussed further below. The database stores a plurality of merchant pages, the plurality of merchant pages being associated with merchant information. In one embodiment, the merchant pages may be indexed in the database according to the merchant information. The mobile device is generally configured to scan and decode a machine-readable code or a derivative thereof and to preferably generate and transmit a signal to the server indicating the completion of the scanning and decoding step, the signal preferably (though not necessarily) being a digitally encoded transmission. Preferably, the machine-readable code encodes at least some of the merchant information. The machine readable code may be provided in any format, such as a 1 D or 2D format, including forms such as a barcode or a QR code. According to a particularly preferred embodiment of the invention, the system and method uses a QR code due to the amount of information that may be encoded therein. Upon decoding the scanned code, the mobile device transmits a signal to the server for gaining access to the database. The server then transmits to the mobile device a merchant page (or pages) associated with the merchant information, or part thereof. As mentioned above, the merchant page (and therefore the merchant information) is stored in the database associated with the server. The merchant page may for example be presented on the web browser of the mobile device or other user interface provided on the mobile device. Preferably, the merchant information comprises a merchant identifier. More preferably, the merchant information further comprises a merchant location identifier.

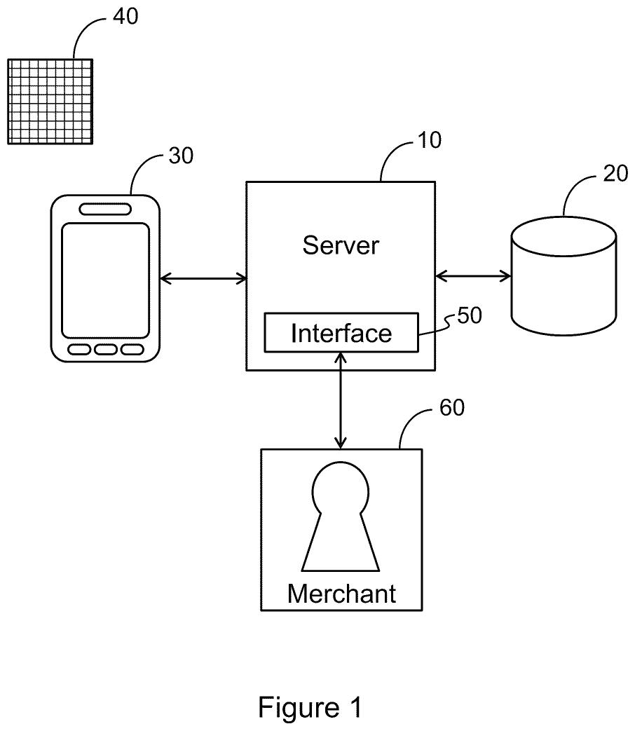

The system according to one embodiment of the invention is illustrated in FIG. 1. As illustrated, the system comprises a server 10 and at least one database 20 accessible by the server 10. One or more mobile devices 30 are able to access the server 10.

The mobile device 30 may be any type of device that is configured to scan and decode the machine-readable code 40. The mobile device 30 generally comprises: an input device or sensor such as a visual image gathering device for visually scanning the machine-readable code 40 and digitally capturing the image of such code, such as a camera; an output device or information displaying device, such as a display screen; a communication module comprising executable code for allowing communication between the mobile device 30 and the server 10; and at least one processor having any number of algorithms encoded thereon, such as algorithms for facilitating the scanning and/or decoding processes and communication step. As will be understood, the mobile device 30 may further comprise additional components including, but not limited to, other input/output devices or modules, a battery, and one or more applications encoded on a processor provided on the mobile device 30. In a preferred embodiment, the mobile device 30 may be a cellular phone or a smartphone.

As indicated above, the mobile device 30 comprises a first application configured to scan process and/or decode the machine-readable code and/or derivative thereof and transmit a signal to the server 10 indicative of the scanning and decoding steps. The first application comprises a set of executable steps programmed on a processor, or other such computer readable and/or accessible memory located on the mobile device. The first application is further configured to cooperate with the sensor or visual image gathering device located on the mobile device. In one aspect, the image gathering device is a camera provided on the mobile device. In addition, the mobile device 30 further comprises a second application configured to receive information from the server 10 responsive to the decoded machine readable code, and display the information received from the server 10. The second application comprises a set of executable steps programmed on a processor, or computer readable and/or accessible memory located on the mobile device. The second application is preferably associated with the information displaying device located on the mobile device. For example, the information displaying device comprises a display screen, operably connected to a processor. The processor having encoded thereon a web browser associated with the mobile device's display screen. In another embodiment, the information displaying device may comprise a text messaging system encoded on the mobile device and associated with the mobile device's display screen.

The mobile device 30 is generally configured to communicate bi-directionally with the server 10 over a communications network. Examples of such communications networks include, but are not limited to, cellular telephone networks, cellular data networks (e.g. GSM, CDMA, and LTE networks) and computer networks including wireless personal area networks, such as Wi-Fi networks and Bluetooth networks.

The machine-readable code 40 is, in one aspect, an optical code encoding one or more items constituting the merchant information. In a preferred example, the machine-readable code 40 is a barcode or, more preferably, a Quick Response (QR) code. In one aspect of the invention, one or more QR codes may be displayed at one or more area throughout a given location, such as a merchant's store. The QR codes may be printed on respective signs associated with, for example, particular products or locations within the store. For example, the machine-readable code 40 may be a QR code printed on a shelf talker that is placed on store shelves adjacent to a particular product. As would be known to persons skilled in the art, shelf talkers are generally shelf mounted signs that are shaped and/or otherwise designed to draw the attention of shoppers to, for example, a particular product or area of the shelf. It will also be understood that the present description is not limited to any particular shelf talker.

The server 10 may be a computing device or a group of computing devices that may be distributed or centralized over a network. The server 10 generally comprises a processor, an electronic memory, and a network communication module for establishing bidirectional communication with the mobile device 30. The server 10 may further comprise additional components including, but not limited to, input/output devices for receiving and sending digital information, operating system software, user interfaces, and application software suitable for executing the functions described herein. In particular, the server 10 would include a modem or other communication hardware, with associated executable code, for establishing a communication link with the mobile device, whereby information is received from and transmitted to the mobile device.

In the embodiment illustrated in FIG. 1, the server preferably comprises a merchant interface 50 accessible by a merchant 60 to permit the merchant 60 to modify or update the merchant page or pages stored in the database 20, as described further below. In other words, the server is configured to be accessible by a merchant over a communication link, whereby the merchant's page or pages stored in the database may be amended or updated as needed. As above, the server may achieve this with a modem or other such communication device accessible by a computer or mobile device associated with the merchant. In a preferred embodiment, manipulation of the merchant's pages requires authenticated access by the merchant or the merchant's designate.

The database 20 is generally an electronic memory device storing a plurality of merchant pages in digital format, each merchant page being associated with respective merchant information. For example, each merchant page may comprise one or more of an electronic document (text) file, image file, audio file, and/or video file. Each of the merchant pages, independently, may optionally also comprise a header, data object, and/or footer, for example. Each of the merchant pages, independently, may optionally comprise information related to in-store promotions at various merchant locations. The merchant page may be in the form of a web page (i.e. encoded in HTML or any other form as would be known to persons skilled in the art) that is designed to be viewed on a user interface such as a web browser provided on the mobile device 30.

Although the database 20 is illustrated as being physically remote from the server 10 in FIG. 1, it will be understood that the database 20 may be integrated within the server 10. For example, the contents of the database 20 may be stored within the electronic memory of the sever 10. Alternatively, the database 20 may reside on the computer readable medium of an external hardware device and may be accessed by the server 10 over a communication network. For example, the database 20 may be accessible by the server 10 over the Internet or a local-area network.

The merchant interface 50 is an interface configured to permit the merchant 60 to modify or update the merchant page or merchant pages associated with the merchant 60. For example, the merchant interface 50 may be a graphical user interface provided on a web page and made accessible to the merchant 50 over any communication network (such as the Internet) on a display device associated with the merchant's computer or mobile device. It will be appreciated that the merchant interface 50 may support a variety of functions for modifying the merchant pages. For example, the merchant interface 50 may enable the merchant 60 to edit texts, upload and/or download files, edit image, audio and/or video files, choose among any number of templates, and/or preview the merchant pages. The merchant interface 50 may further provide any number of authentication mechanisms for selectively permitting the merchant 60 access to modify or update the merchant page(s) stored on the database 20.

The merchant interface 50 is accessible by the merchant (or merchants) independently of users. That is, a merchant is able to access the server (preferably following any desired authentication procedure) and access its merchant pages or its information stored on the server and manipulate same in any manner. For example, the merchant may manipulate one or more of its merchant pages so as to change the information presented to a user (upon decoding of a code as described above). In another example, the merchant may choose to manipulate the merchant information associated with a given code (i.e. QR code) so that a different merchant page is displayed to user when the code is scanned and decoded. Thus, in this way, a merchant may store any number of merchant pages on the server, each associated with a different code. In one example, the merchant may associate a different merchant page based on its various locations; i.e. a location based differentiation. In another example, the merchant may associate a different merchant pages based on specific products; i.e. a product based differentiation. In yet another example, the merchant may choose to associate merchant pages by both location and product; i.e. differentiation based on location and product. For example, a code associated with product 1 at location 1 may present a different merchant page as compared to a code associated with product 1 and location 2. As will be understood, the level of such differentiation would be entirely up to the merchant's desired level of customization. Since the merchant pages are managed by the merchant, the merchant is able to manipulate the information provided to the user at any time and in any manner.

It will be appreciated that the components of the system illustrated in FIG. 1 may communicate with one another over a variety of communications networks. For example, such communications networks include, but are not limited to, cellular telephone networks, cellular data networks and computer networks including wireless personal area networks, such as Wi-Fi networks and Bluetooth networks.

According to one embodiment of the invention, a user scans a machine-readable code 40 using a mobile device 30. As mentioned above, the process of scanning is accomplished by means of a sensor or a camera etc., provided on the mobile device 30. The machine-readable code 40 may, for example, be a QR code displayed on a store shelf and may comprise information related to such product or other products or services provided by the merchant at that or other locations. A processor on the mobile device 30 then decodes the machine readable code using a decoding algorithm encoded on the processor. The mobile device 30 then transmits a signal over a communication network to the server 10 indicating that the machine-readable code has been scanned and decoded. In one aspect, the signal comprises merchant information digitally encoded in the code 40.

The server 10, upon receiving the signal from the mobile device 30, processes the signal to identify the associated merchant information and queries the database 20 for the merchant page(s) associated with the merchant information. Alternatively, if the server 10 receives a signal from the mobile device 30 indicative of a decoded machine readable code, the server 10 may query the database without further processing the signal received from the mobile device 30. Once the merchant page or pages associated with the merchant information is/are identified in the database 20, such page or pages are transmitted by the server 10 to the mobile device 30. The mobile device 30 then presents the transmitted merchant page(s) to the user on the mobile device's display screen, or any other such output device. As indicated above, and in a preferred embodiment, the display of the merchant page(s) is accomplished using the mobile device's browser as the user interface. Alternatively, any other software system associated with the mobile device's display screen, or any other output device, may be used for displaying the merchant page(s). For example, in one embodiment, the output device may be the mobile device's speaker and the merchant page transmitted may encode an audio file for playback on the speaker.

As will be understood, in one embodiment each unique machine-readable code will generate a unique signal that is transmitted to the server in response to which a unique set of information is returned to the mobile device 30 (as discussed further below). In another embodiment, a group or collection of codes may generate a common signal that is transmitted to the server. Alternatively, any number of different signals may be associated with unique or common merchant information so that a unique merchant page or different merchant pages are transmitted to the user. Thus, in one embodiment, the server may associate one or more decoded signals with a given merchant page or, alternatively, one decoded signal may result in more than one merchant page being displayed on the user's mobile device.

In one example, machine-readable codes in the form of QR codes may be printed and displayed on shelf labels, or shelf talkers, displayed throughout the store or stores owned by or associated with a merchant. In the latter case, for example only, the merchant may be a franchisor and the stores may be franchisee locations. The QR codes displayed at each store or at each location within a given store may be the same or different. For example, in one aspect, the merchant information encoded in the QR codes may include the physical location of the respective stores or the physical location of the QR code within a given store, with such merchant information being transmitted by the user's mobile device one the QR code is scanned. In such cases, the merchant page(s) transmitted to the user's mobile device may contain specific information related to particular in-store promotions being offered at one or more store locations or at one or more locations within a given store. The QR codes may also be associated with respective products or group or class of products, whereby the respective merchant page(s) transmitted to the user may comprise information or special offers related to such products or group and/or information related to other complementary products or groups that the merchant wishes to bring to the attention of the user.

In either of the above cases, or others discussed herein or apparent to persons skilled in the art, it will be understood that one particular advantage that is realized by the present system and method is that the merchant is entirely in control of what information is presented to a user (through the merchant page(s)) at any given time and that such presented information may be tailored by the merchant on a real-time basis using the merchant's unique interface 50. Further, since the information is hosted on the server of the system, it is not necessary for the merchant to maintain any architecture or systems for running the present system. In addition, the merchant's own website would not need to be altered to accommodate the system and method of the present invention. In one example, the merchant's URL to its web site may be provided to the user as part of the merchant's page(s) transmitted to the user. For example, the merchant's URL (or “home page”) may be presented as an HTTP link on the merchant page displayed on the user's mobile device (as described above).

It will also be understood that the system and method disclosed herein would be advantageous for merchants (or retailers) as compared to traditional advertising methods since the content that is presented to the customers (i.e. users) can be modified or updated without changing the physical signage posted throughout the stores. That is, as discussed above, a merchant may amend at any time any of the information presented to a user in response to the scanning of a particular QR code. In one example, since the machine-readable codes may be posted at a plurality of locations throughout each of the merchant's stores, a customer in one part of the store who scans a nearby code may be presented with a merchant page containing information relating to a product at another part of the store without physically moving to another location within the store. For example, a user may scan a QR code associated with sliced bread and be alerted to a price special on sandwich meat or mayonnaise (etc.) that is located at a different location. This example may involve a “you may also like” page outlining information on a complementary product.

In the above discussion, the merchant pages that are presented to a user have been described as containing information related to specific products or services within one or more of the merchant's stores. However, in other embodiments, the merchant pages may include any amount of other information that a merchant may wish to provide to a user. For example, a merchant selling groceries may display recipes using the product associated with the scanned code, as well as information on the ingredients of such recipe. In another example, in the case of a merchant selling women's, a user scanning a code associated with a coat may be presented with information on fashion accessories etc. that may or may not be related to the coat. In another example, the merchant page may include advertisements or information relating to any of the products or services provided by the merchant.

In one embodiment, the server 10 comprises the merchant interface 50, which is accessible by the merchant 60 to enable the merchant 60 to modify or update the merchant page(s) associated with the merchant information. As indicated above, the merchant interface 50 is preferably a graphical user interface provided, for example, on a web page and made accessible to the merchant 50 over a communication network. Upon the merchant 60 accessing the web page, the merchant interface 50 may prompt the merchant 60 to provide any necessary authentication information. Such authentication information may include, but is not limited to, a username, merchant identifier, merchant location identifier, password, token, or any combinations thereof. As indicated above, the merchant accesses the server hosting the merchant interface using any appropriate communications device such as the merchant's computer (e.g. desktop, laptop, tablet etc.) or mobile device (e.g. smartphone or cellphone etc.). Once the merchant 60 has been authenticated, the merchant is presented with a respective merchant interface 50 through which, the merchant may view, add or amend any information stored in the database 20 and that is associated with the merchant. For example, the merchant may be presented with a listing of merchant pages stored in the database 20 that is associated with the merchant 60 upon authentication. The merchant may then select a given merchant page and amend the content therein or amend the merchant information associated with the page.

It will be appreciated that the merchant interface 50 may provide the merchant 60 with a variety of additional information. In one preferred embodiment, such additional information may comprise statistics relating to the merchant pages, such as the number of unique visitors and/or the number of accesses made by users to the respective pages. According to another embodiment, the merchant is able to reset any of the statistical information and/or change the type and nature of statistics that are gathered.

As mentioned above, once the merchant 60 has been authenticated and has been granted access to its account, the merchant may then modify and/or update the content stored on the database 20 that is associated with the merchant 60. For example, the merchant may upload or create a new merchant page, add a new store location to the database 20, and/or modify or update an existing merchant page. In one embodiment, the merchant page contains information related to an in-store promotion or offer. For example, the merchant page may be an advertisement of the items on sale for the week, the day or the hour. The merchant page may also be, for example, an announcement of changes to the store hours or location, and/or advertisement of new services or products being or to be offered by the merchant.

In one embodiment, the merchant may have grades of access rights to the merchant interface. For example, one level of access may allow the individual logged on to be able to make any changes, additions or deletions to the merchant page(s), while in another level of access, the individual may only be permitted to edit existing pages. It will be understood that multiple access levels may be established as required.

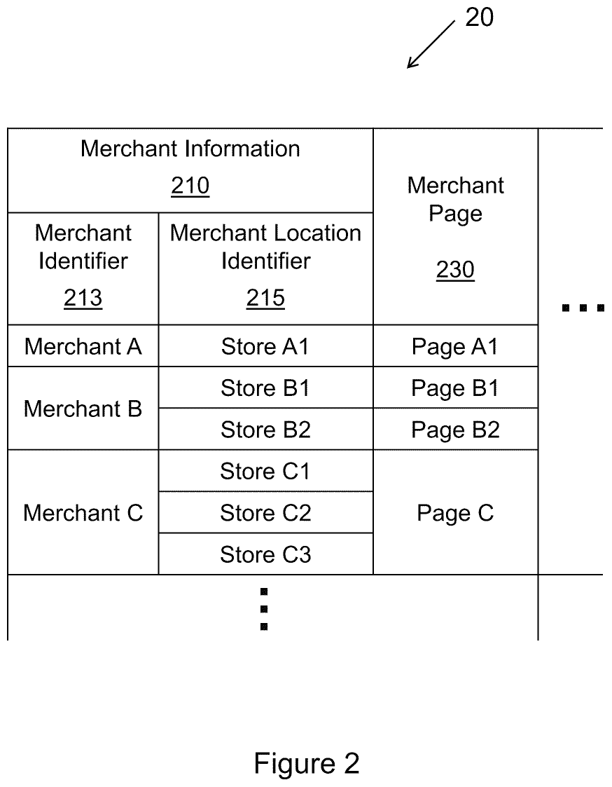

The database 20 may be configured to permit the merchant 60 to associate a merchant page with one store location or a plurality of store locations. The structure of the database 20 according to one embodiment is illustrated in FIG. 2.

In the aspect of the invention illustrated in FIG. 2, the merchant information 210 comprises a merchant identifier 213 and a merchant location identifier 215. For example, the merchant identifier 213 may be the name of the merchant or retailer or ideally a unique code for identifying a given merchant. The merchant location identifier 215 may be the physical location of the merchant's establishment, which may be associated with the street address, city, town, and/or regional identifier for each store location owned and/or affiliated with the merchant. The merchant location identifier may alternatively, or in combination, be representative of a physical location of the machine readable code within a given store. In one embodiment as illustrated in FIG. 2, each merchant page 230 is preferably associated with a merchant identifier and a merchant location identifier. For example, Page A1 is associated with Store A1 of Merchant A, while Page C is associated with Store C1, Store C2, and Store C3 of Merchant C. As will be understood, such database structure permits the merchant with multiple store locations to associate a merchant page with all of the store locations, or only some of the store locations. This is particularly advantageous for large retailers wishing to advertise the same information to customers visiting multiple store locations. It will also be understood that in other embodiments, a given merchant may not require the merchant location identifier. For example, in the case of merchant having only a single location, the merchant location identifier, if present, may simply be a common, static value. In other embodiments, the merchant location identifier may not be part of the merchant information.

As illustrated in the embodiment shown in FIG. 2, Merchant A may access the merchant interface 50 to modify or update Page A1 associated with the merchant, Merchant B may access the merchant interface 50 to modify or update Page B1 and Page B2 associated with Store B1 and Store B2, respectively, and Merchant C may access the merchant interface to modify or update Page C, which is associated with Store C1, C2, and C3. If desired, Merchant C may change the stores associated with Page C, such that Page C is only associated with one or two of the store locations, for example.

In one embodiment, access to the database 20 through the merchant interface 50 may be limited on a store-by-store basis. For example, the store manager of each store location may be provided with separate credentials for accessing and managing the merchant page 230 associated with their merchant location identifier. This may be advantageous, especially if the merchant is a franchisee and the franchisor wishes to have each franchisee manage their own in-store promotions.

As indicated above, an advantage provided by the present invention is that the merchant pages may be updated in real-time. For example, any changes made by the merchant 60 to the merchant page are reflected in the database 20 immediately, such that the new or amended merchant page is transmitted and/or updated immediately to the user's mobile device.

Returning to FIG. 1, in a preferred embodiment of the invention, the server 10 and the database 20 are maintained by a service provider. The merchant 60 may request the service provider to create an account and to add one or more of the merchant's store locations to the database 20. The service provider may then update the database 20 to associate new store locations with the merchant identifier of the merchant 60. The service provider may also provide the merchant 60 with the machine-readable code 40 encoding the merchant information. These may be provided, for example, as QR codes printed on shelf talkers to be displayed on the shelves of the merchant's stores. The merchant 60 may then access the merchant interface 50 to add new merchant pages to be associated with the merchant information of the merchant 60. It will be appreciated that, for example, the new merchant pages may be associated with the merchant identifier and/or merchant location identifier.

A customer, or user, visiting the merchant's store may then use a mobile device 30 to scan the QR code and receive on such device the associated merchant page(s) from the server 10. As discussed above, the mobile device 30 would comprise a processor or computer readable medium encoding an algorithm or application configured to scan the QR code and communicate with the server 10. For example, such application may be provided by the service provider and made available to the mobile device 30. That is, the service provider may offer users with a unique application able to be downloaded onto the user's mobile device, for example from the service provider's website. Once downloaded onto the user's mobile device, such application would permit the scanning and/or decoding of the service provider's code, such as the QR codes discussed above.

As discussed above, the method and system of the invention offers the advantage that it does not require the merchant to manipulate its own server, database and/or website. Rather, a given merchant page is stored on the database 20 hosted on the server maintained by the service provider. As will be understood, this is of particular advantage where a merchant wishes to modify or advertise information specific to one or more specific locations as opposed to doing so across the entire range of locations. In addition, the merchant interface of the invention provides merchants with an ease of use that may not be achievable using common website manipulation tools, such as HTML editors at the like. As will be understood, the manipulation of a website typically involves intervention by the merchant's information technology (“IT”) department, whereas with the present invention, any member of the merchant's staff, once approved, would be able to easily modify the merchants pages as needed.

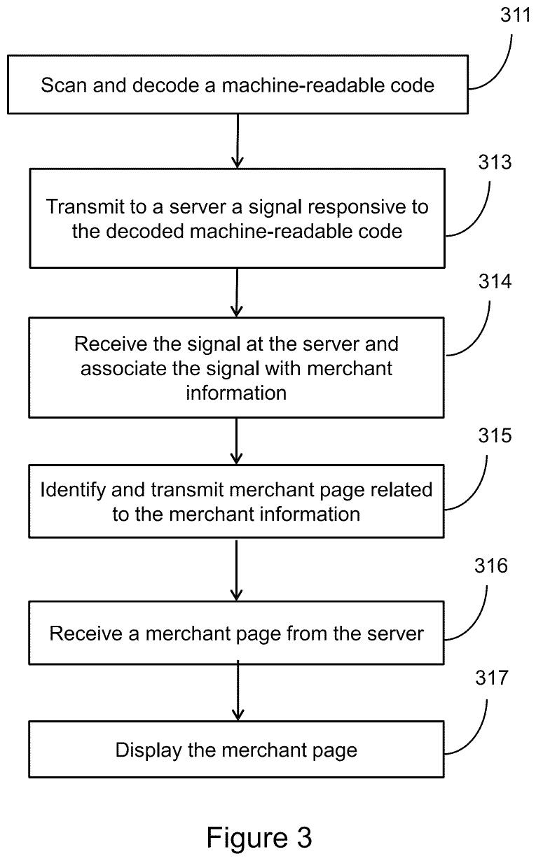

One embodiment of the invention comprises a method as illustrated in FIG. 3. As shown, in step 311, the mobile device scans and decodes a machine-readable code, such as a QR code. In step 313, the mobile device transmits to the server a signal responsive to the decoding of the machine-readable code. In one aspect, the signal may be a digital format of the image representing the code itself. That is, the mobile device simply digitally transmits the machine readable code without analysing the code further. In step 314, the signal from the user's mobile device is received at the server and the merchant information associated with the machine-readable code is identified. In step 315, the server identifies merchant page(s) associated with the merchant information and transmits such merchant page(s) to the mobile device. In step 316, the mobile device receives the merchant page(s) from the server. In step 317, the mobile device presents the merchant page to the user, such as by displaying the merchant page on a display screen of the user's mobile device.

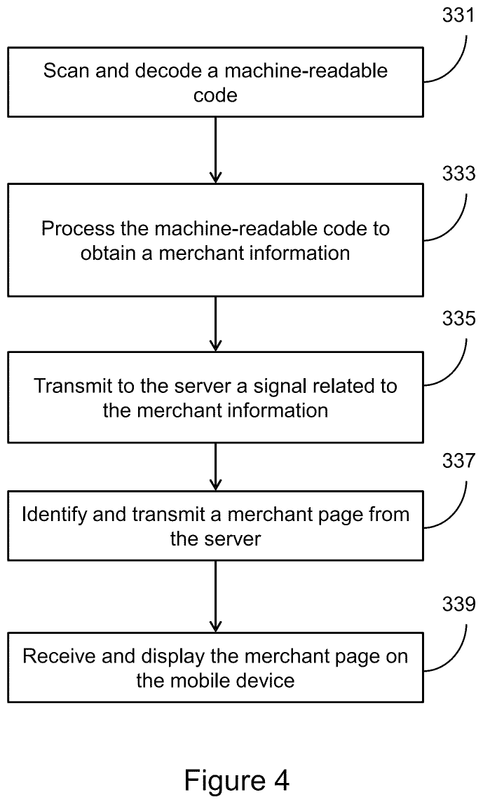

Another embodiment of the method for presenting a merchant page on a mobile device is illustrated in FIG. 4. As shown, in step 331, the mobile device scans and decodes a machine-readable code. In step 333, the mobile device processes the machine-readable code to obtain the merchant information encoded on the machine readable code. For example, the merchant information may comprise the merchant identifier and/or the merchant location identifier. This step is preferably accomplished by the application that is used to scan and decode the code. As indicated above, in a preferred embodiment, such application is provided by a service provider that maintains the server and establishes the machine-readable codes. As will be understood, in this embodiment, the mobile device is able to process the scanned code information to identify merchant information. In step 335, the mobile device transmits a signal to the server, the signal being related to or encoding the merchant information. In step 337, the server identifies merchant page(s) associated with the merchant information transmitted by the mobile device and transmits the web page(s) to the mobile device. In step 339, the mobile device receives the merchant page(s) transmitted by the server and displays such merchant page(s) on the display screen of the mobile device.

In the embodiments described above, the information transmitted to the user is triggered by the user scanning a code, such as a QR code provided on a sign, such as a shelf talker. In another embodiment, the shelf based signs, or shelf talkers, may be provided with a transmitter, or “beacon”, which would avoid the need for the user to scan a code. In this embodiment, the beacon would have a predetermined field of transmission and would trigger information, such as the merchant page(s) described above, being transmitted to the user's device once the device enters the transmission field of the sign. In this embodiment, the sign may be programmed to automatically deliver specific content (e.g. specific merchant page(s)) to the user's mobile device. Specifically, the user's mobile device will include an application programmed to sense the signals emitted by the beacon. In one embodiment, the user may be prompted (either electronically or by signage etc.) to download the application onto their mobile device upon first entrance to the merchant's site (i.e. a store). The application may be allowed to remain loaded on the user's mobile device thereby not requiring the user to reload the application again. The application would be programmed to allow the mobile device to receive and decode the transmission from the beacons on the signs. Based on the signal from a given beacon, the mobile device would be instructed to send a signal encoding merchant information to the serve in the same manner as described above. That is, in this embodiment, the step of scanning a code (such as a QR code etc.) is replaced by the mobile device automatically sensing the beacon, wherein the transmission of a signal by the mobile device (as described above) is also automatic. The signal transmitted by the mobile device is processed can be processed in the same manner as indicated above so that relevant merchant page or pages are delivered to the mobile device for display to the user.

In the same manner as described above, the delivered content according to this embodiment can be tailored as desired by the merchant. It would be understood that a given merchant site can be provided with any number of such beacons as needed or desired by the merchant. It will also be understood that the above embodiment incorporating beacons may also be combined with the previous embodiment wherein a user scans a code. In other words, both coded signs and beacons can be incorporated into one location, whereby a user may be delivered content that is generated by the code scanning step or automatically using the beacon(s).

It will be appreciated that although certain embodiments and examples of the systems, methods, and/or computer devices have been explained with reference to “a mobile device” and “a merchant”, the systems, methods and/or computer devices of the present invention would work in substantially the same manner with a plurality of mobile devices and a plurality of merchants.

Although the invention has been described with reference to certain specific embodiments, various modifications thereof will be apparent to those skilled in the art. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The scope of the claims appended hereto should not be limited by the preferred embodiments set forth in the above description, but should be given the broadest interpretation consistent with the present specification as a whole. The disclosures of all prior art references recited above are incorporated herein by reference in their entirety.

1. A method for transmitting at least one relevant merchant page to a mobile device over a communication network, the method comprising:
providing:
a computer server connected to a communication network;
a database accessible by the server, the database comprising an electronic memory having stored thereon a plurality of merchant pages, each of said merchant pages being associated with respective merchant information, the merchant information comprising an identity and/or location of a merchant, and said merchant pages containing content customized by the merchant;
a processor, coupled to the server, the database, and the communication device, the processor being programmed with executable code;
receiving at the server, a signal from the mobile device, the signal encoding merchant information and an information request;
wherein the processor:
A) authenticates access by a merchant to respective merchant pages through a merchant interface, thereby permitting customization of the respective merchant pages; and,
B) independent of A):
processes the signal to identify the merchant information encoded by the signal;
accesses the database containing a plurality of merchant pages;
identifies in the database, the at least one relevant merchant page, wherein said at least one relevant merchant page comprises at least one merchant page associated with the merchant information identified in the signal; and,
transmits the at least one relevant merchant page to the mobile device.

2. The method of claim 1, wherein the signal is generated by a user scanning a machine-readable code using the mobile device.

3. The method of claim 1, wherein the signal is generated by the mobile device upon the mobile device entering into a transmission field of a beacon located at a location.

4. The method of claim 1, wherein the plurality of merchant pages stored on the database is indexed according to the merchant information.

5. The method of claim 2, wherein the machine-readable code is scanned and decoded by the mobile device.

6. The method of claim 5, wherein the merchant information is identified by the mobile device.

7. The method of claim 5, wherein the merchant information is identified by the computer server.

8. A system for presenting at least one relevant merchant page on a mobile device, the system comprising:
a computer server connected to a communication network;
a database accessible by the server, the database comprising an electronic memory having stored thereon a plurality of merchant pages, each of said merchant pages being associated with merchant information of respective merchants, and containing content customized by the merchant;
a processor, coupled to the server, the database, and the communication device, the processor being programmed with executable code;
the server comprising a merchant interface accessible by merchants, wherein the processor is programmed to authenticate a merchant and to permit the merchant access to customize respective merchant pages associated with the merchant;
the processor further being programmed to:
receive a signal from the mobile device, the signal encoding an information request and merchant information associated with at least one merchant page;
query the database to identify at least one merchant page associated the merchant information; and
transmit the at least one merchant page to the mobile device.

9. The system of claim 8, wherein the signal is generated by a user scanning a machine-readable code using the mobile device.

10. The system of claim 9, further comprising a plurality of machine-readable codes at a plurality of merchant locations.

11. The system of claim 8, wherein the signal is generated by the mobile device upon the mobile device entering into a transmission field of a beacon.

12. The system of claim 11, further comprising a plurality of beacons at a plurality of merchant locations.

13. The system of claim 8, wherein the plurality of merchant pages is stored on the database is indexed according to the merchant information.
